(19) United States
(12) Patent Application Publication
(10) Pub. No.: US 2023/0199149 A1
(43) Pub. Date: Jun. 22, 2023

(54) Removably Engageable Vehicle Monitoring System

(71) Applicant: Larry Wilson, Prineville, OR (US)

(72) Inventor: Larry Wilson, Prineville, OR (US)

(21) Appl. No.: 17/883,380

(22) Filed: Aug. 8, 2022

Related U.S. Application Data
(60) Provisional application No. 63/291,607, filed on Dec. 20, 2021.

(51) Int. Cl. H04N 7/18; H04N 5/232; G08G 1/16; H04N 5/77; H04N 5/225

(52) U.S. Cl. CPC H04N 7/181; G08G 1/162; H04N 5/77; H04N 5/2252; H04N 5/23299; H04N 5/232411; H04N 7/188; G08G 1/168

(57) ABSTRACT

A vehicle monitor is provided to monitor the area adjacent to a parked vehicle on which the monitor is engaged. Cameras and microphones can be mounted on the housing to capture video from persons and vehicles which may move to positions adjacent the vehicle on which the monitor is operating. Captured video is employable to identify any person or vehicle which might contact and damage the vehicle being monitored, and warning lights and indicia may be activated to warn persons proximate to the monitored vehicle they are being recorded.

### BACKGROUND OF THE INVENTION

### 1. Field of the Invention

This application claims priority to U.S. Provisional Pat. Application serial number 63/291607 filed on Dec. 20, 2021, which is incorporated herein in its entirety by this reference thereto.

The invention herein disclosed relates generally to motor vehicles, such as passenger cars and trucks. More particularly, it relates to a removably positionable vehicle monitoring system which is placed in a user vehicle, which will monitor for the presence of humans and vehicles positioned adjacently thereto and, upon triggering, will capture a video recording thereof for future review.

### 2. Prior Art

### Background of the Invention:

Motor vehicles, such as cars and trucks, have become the primary mode of transportation of people in most industrialized countries. Such vehicles provide transportation for their owners and occupants between their home and various venues such as workplaces and shopping centers and the like.

In between movement of such vehicles over streets and highways, such vehicles are conventionally parked in designated parking areas. However, in a parking lot congested with vehicles closely-positioned in designated parking spots, such parking lots can be a recipe for costly damage to parked vehicles.

While parked in such lots, having tight parking spaces and a significant number of different vehicles coming and going from multiple parking spots, damage can be easily caused to adjacently parked vehicles by inattentive drivers leaving and entering their own parked vehicles. Because of the sheer number of vehicles parking and leaving such parking lots, it is generally hard to discern and to prove who caused damage. Damage caused by dings, dents, and other human and vehicle contact with adjacent vehicles in such parking lots and structures can be costly to repair. This type of potential damage significantly increases vehicle insurance rates for those submitting claims for such damage.

With respect to the above, before explaining at least one preferred embodiment of the removably engageable vehicle monitoring system herein, it is to be understood that the disclosed system herein is not limited in its application to the details of employment and to any arrangement of steps set forth in the following description or illustrated in the drawings. The various apparatus components and configurations, and methods of employment thereof as herein disclosed, are capable of other embodiments, and of being practiced and carried out in various ways, all of which will be obvious to those skilled in the art once the information herein is reviewed.

Also, it is to be understood that the phraseology and terminology employed herein are for the purpose of description for an understanding of the device and system herein and should not be regarded as limiting. As such, those skilled in the art will appreciate that the conception upon which this disclosure is based may readily be utilized as a basis for other vehicle monitoring systems. It is important, therefore, that the embodiments, objects and claims herein, be regarded as including such equivalent construction and methodology insofar as they do not depart from the spirit and scope of the present invention.

### SUMMARY OF THE INVENTION

The apparatus and system herein provides for the ongoing warning to others of their proximity to the vehicle having the system thereon through the provision of lights and/or visible indicia which is visually discernable by humans proximate to the device. Concurrently with warning lights, the device and system provide ongoing video monitoring of the area surrounding a vehicle while the vehicle is parked in a lot, such as at a shopping center, parking structure, or for example, even such parking locations at a home or office of the user.

The device herein disclosed and described, in all preferred modes, includes a housing having a projecting mount extending therefrom which is adapted for removable engagement with a vehicle door window. The projecting mount is formed preferably as a thin flexible member configured for positioning in a slot located between a vehicle door window of a vehicle and the window felt or padding adjacent thereto on the interior of the vehicle door. Conventionally, cars and trucks have doors with retractable windows positioned thereon wherein the windows retract into such slots in the door.

Thus, the provision of a housing for the operational components of the device, which has such a projecting mount sized to slide between the window glass and the felt or padding positioned adjacent thereto in the window slot, allows the device herein to be removably engaged to the majority of the cars and trucks employed on the roadways. The device can, thus, be moved from vehicle to vehicle and mounted as needed, or it can be easily removed for storage and easily remounted.

In one mode of the device, the projecting mount is stationary and projects from one side of the housing which currently is described herein as a bottom side thereof. In another preferred mode of the device, the projecting mount is pivotally engaged and projects from one side surface of the housing. The pivoting engagement allows for angled positioning of the housing and the projecting mount to accommodate vehicle windows which may be at an angle where a fixed projecting mount would not be easily engaged.

In other modes of the device herein, it is configured for positioning upon a front or rear dashboard. When so positioned, the projecting mount can be rotated to hold the housing in a substantially upright position wherein onboard video cameras can record occurrence in areas surrounding the vehicle, and onboard warning lights are visible to humans venturing into the areas surrounding the vehicle. Where the projecting mount is rotationally engaged to the housing of the device, it can be positioned either on a door window or supported on the front or rear dashboard of the vehicle.

Within the housing, the device includes an impact sensor, such as an electronic accelerometer, which provides a trigger signal to the device to activate it. Such an impact sensor can sense impact upon the vehicle to which the device is engaged, or in some modes, it can sense sound waves of an impact of the closing of an adjacent vehicle door. By impact sensor herein is meant an electronic component which will generate an electronic signal upon sensing a movement of the vehicle on which the device is mounted, and/or, an impact or a sound thereof adjacent the vehicle on which the device herein is mounted. The impact sensor can be a combination of an accelerometer and microphone, thereby rendering it able to sense both motion and noise adjacent the vehicle and to then communicate an impact signal to the device to energize. This signal can be one or both of a sound from the microphone or sensed movement from the movement sensor such as the accelerometer.

Upon sensing impact, the impact sensor will communicate such an electronic activation signal to an onboard microprocessor, operatively engaged to electronic memory, and electric power, to cause software operating to the task of energizing the device for a defined duration of time to trigger it to an on or energized state. Upon the passing of a predetermined time duration, absent the sensing of movement or impact to or adjacent the vehicle, software running to the task in electronic memory of the device may cause the microprocessor and electronic components to change to a low energy state, awaiting the next impact or sound sensing or a sensing of movement by one or more onboard cameras.

Immediately upon being triggered by the impact sensor signal, to activate the device, software running in electronic memory in communication with the onboard microprocessor will operate to the task to activate the device to record video and/or sound from areas adjacent to the vehicle on which it is engaged.

For such video recording, at least one and preferably a plurality of video cameras are engaged with the housing to capture one or preferably multiple video streams from different angles. While a single video camera will work to capture video of surrounding areas, the positioning of multiple video cameras which capture video from multiple areas at multiple angles to the device allows it to capture much more video information. For example, one video camera can be angled to capture areas immediately adjacent to the side of the car on which the device is mounted, and a second video camera can be positioned at an angle to capture the front or the rear of a vehicle entering a parking space next to the vehicle on which the device is mounted. Currently preferred are at least two video cameras which project above a surface of the housing to enable them to capture better video recordings from multiple angles which would not be possible if they were flush-mounted.

The two or more video streams, so captured, will allow for video images of license plates or other identifiers of an adjacent vehicle and allow for the capture of the face or other identifying characteristics of the driver of the adjacent vehicle. In the event of a determination of damage to the vehicle on which the device is engaged, review of the captured video and audio compared to a time discerned of an impact, can be employed to determine the identity of the offending vehicle and/or driver thereof.

In an additional means for activation, where sufficient onboard battery energy is available, using software running in electronic memory operating to the task of sensing movement in pixels of video streams communicated from the cameras, the device may be activated to full operational power. Such would be caused by movement sensed in the pixels of captured video steams, such as by monitoring the entire video display formed by the pixels therein for changes.

In a preferred mode of video capture, to allow for self-authentication of captured imagery as to day and time, a GPS receiver and electronic clock, operatively connected to the microprocessor and electronic memory of the device, can communicate the date and time and the terrestrial location of the device during times of activation. The captured electronic images from the one or plurality of cameras can be date and time stamped with viewable indicia thereby self-authenticating the date and time of each video and audio recording.

An electronic signal from the GPS receiver can also be employed to location-stamp each recorded video for the longitude and latitude of the device at the time of capture. Using a lookup table of geographic locations or mapping programs such as Google Earth, an exact terrestrial location of the position of the device during the duration of any captured video and audio, can be determined. In the same fashion as the time and date stamp, the captured videos and any audio can be electronically encoded with a location stamp, which can appear within the frame of the video as indicia which can be an address or a well known location or the like.

The electronic video streaming from the one or plurality of video cameras, with any time, date, and/or location stamping, along with any audio recording if captured, is stored in electronic memory of the device as conventional media files. By media files is meant herein electronic files which are stored in electronic memory which will produce video on a display and audio when played by a computing device having conventional Windows or Apple media-playing software. Thereafter, such media files can be communicated by wired or wireless communication, such as by USB cable, Bluetooth, Wifi or other communication, to a computing device for review. Alternatively, the portion of onboard electronic memory employed for video capture and storage can be removable, such as by using a removable memory card.

In an alterative mode of activation of the device herein, a remote control can be employed to communicate a wireless signal to a wireless receiver on the device. Once such a signal is received, in the same fashion as the impact sensor, sound, or movement sensing, an electronic signal is sent to the microprocessor to activate the device and run the appropriate software programs thereon.

Where the device is meant to not only be a stealth activity recorder but also a warning, the housing holding the cameras and microphone and operative electronics and power source, such as a battery, can also include flashing lights and/or illuminated warning indicia. Upon activation by the remote control or impact sensor or sound sensor, the warning lights will actuate to illuminate and/or blink to reveal the device is present and monitoring surroundings. The sight of blinking lights and/or illuminated indicia warning of activation to human drivers entering a parking spot next to the vehicle having the device herein, may cause them to be subsequently much more careful in how they exit and enter their vehicle, so as to avoid causing damage.

As noted, the device herein can also be positioned on a front or rear dashboard area, adjacent the front windshield or rear glass of the vehicle. In such a positioning, the device is provided with either the pivoting projecting mount and/or a deployable rear support which will allow it to sit supported atop the vehicle dashboard or surface area adjacent the rear window. Operation would be the same as noted above for the window-slot mounted mode of the device.

In another mode of the device, a secondary remote video capturing component can be included to allow for additional video streams of the surrounding area from other angles. This secondary video capturing component will be in operative wired or wireless communication with the primary or main housing component having the battery and microprocessor and electronic memory in which the software adapted to the tasks noted herein will run. Where a secondary video capturing unit is employed, it may be positioned on the opposite side of the vehicle from that of the primary component. Such will allow for capture of video and/or audio, in multiple video media streams from the other side of the vehicle from the primary housing, or from one of a front or rear window on the same side of the vehicle where the primary housing is engaged with the other of the front or rear door window.

With respect to the above summary description, before explaining at least one preferred embodiment of the removably engageable vehicle monitoring system herein, it is to be understood that the invention is not limited in its application to the details of operation nor the arrangement of the components or the steps set forth in the following description or illustrations in the drawings. The various methods of implementation and operation of the device herein, are capable of other embodiments and of being practiced and carried out in various ways which will be obvious to those skilled in the art upon their review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other modes for carrying out the several purposes of the present vehicle monitoring device. Therefore, the objects and claims herein should be regarded as including such equivalent construction, steps, and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Where used herein, if not otherwise defined, the term “substantially” means plus or minus five percent.

It is an object of this invention to provide for the monitoring of areas surrounding a vehicle and to keep a video and/or audio record of other vehicles and persons entering and leaving such surrounding areas.

It is a further object of this invention to provide such surrounding-area monitoring through the provision of a removably positioned housing which is activated to record video and/or audio activity of the surrounding areas of a vehicle by one or both of remote control and sensing impact or sounds adjacent the vehicle.

It is a further object of this invention to provide such a video monitoring device for a vehicle which can be easily moved from vehicle to vehicle.

These together with other objects and advantages, which become subsequently apparent reside in the details of the construction and operation of the vehicle monitoring device and system herein as more fully hereinafter described and claimed, reference being had to the accompanying drawings forming a part thereof, wherein like numerals refer to like parts throughout.

Further objectives of this invention may be ascertained by those skilled in the art as brought out in the following part of the specification wherein detailed description is for the purpose of fully disclosing the invention without placing any limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed vehicle monitoring system herein. It is intended that the embodiments and figures disclosed herein are to be considered illustrative of the invention herein, rather than limiting in any fashion.

In the drawings:

FIG. 1 shows a front view of a mode of the device herein showing components of the device and system herein showing a primary housing having a projecting mount and video cameras thereon, a secondary housing having video cameras thereon, and a user actuated remote control.

FIG. 2 shows the components, as in FIG. 1 or FIG. 8, operatively positioned on one or more doors of a vehicle.

FIG. 3 depicts a mode of the device of FIG. 1 or FIG. 8 operatively positioned adjacent a windshield of a vehicle.

FIG. 4 shows the primary housing of the device herein having a pivoting projecting mount.

FIG. 5 shows the device as employable in FIG. 3 having a pivoting support member extendable from a rear side thereof and having the projecting mount on an opposite side.

FIG. 6 shows a rear perspective view of the device, as in FIG. 5.

FIG. 7 depicts a mode of the device having a pivotally engaged mount having a projecting mount having an offset portion, which is rotatable between a stowed position as in FIG. 8 to various deployed positions.

FIG. 8 shows another view of the device as in FIG. 7.

FIG. 9 depicts a side view of the device of FIGS. 7-8 showing the projecting mount rotated to a stowed position.

FIG. 10 shows a side view of the device wherein the projecting mount is rotated to a position to support the housing on a front or rear dashboard area.

FIG. 11 depicts the device in the mode of FIGS. 7-8 wherein the projecting mount is rotated to engage a door window slot and the offset portion positions the housing a space from the window aligned with the slot allowing for an angled positioning of the housing.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right, first, second, and other such terms refer to the device as it is oriented and appears in the drawings and all such terms are used for convenience only and such are not intended to be limiting or to imply that the device and system has to be used or positioned in any particular orientation.

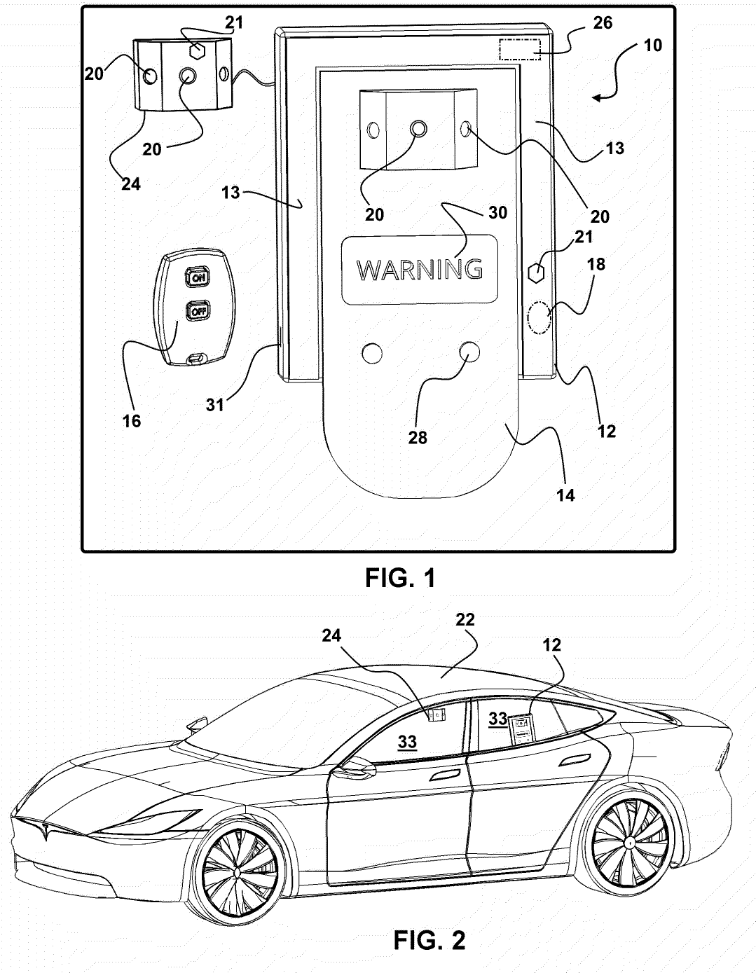

Now referring to drawings in FIGS. 1-11, wherein similar components are identified by like reference numerals, there is seen in FIG. 1 an overhead or front view of the housing 12 of the device 10. As can be seen, a projecting mount 14 extends from a side surface, such as a bottom of the housing 12. The projecting mount 14 is sized and configured to slide into a slot adjacent a vehicle door window, as shown in FIG. 2. Consequently, the projecting mount, preferably, has a smooth surface and curved edges, as shown, and a thickness D (FIG. 11). The thickness D is between 1/16 of an inch to 1/4 of an inch, and in a particularly preferred mode, substantially 1/8 of an inch, which has been shown in experimentation to work well in many more vehicles as it is smaller in size than the slot in which engages in such. This thickness helps to avoid damaging vehicle window components inside and adjacent the slot. The material forming the projecting mount 14 is preferably slightly flexible to allow for easier engagement into the window slot. A polymeric material such as polypropylene or polyethylene works well due to the elastic nature of polymeric materials to bend and return to a planar configuration.

Shown also in FIG. 1 is an optional remote control 16. As noted above, the remote control 16 can be optional and/or be employed to activate the device 10 in combination with the noted impact sensor 18. As noted, by impact sensor 18 herein is meant an electronic sensor which will generate an electronic trigger signal upon sensing an impact to the vehicle and/or sensing a sound of an impact, and/or sensing a sound of opening door or the like of an adjacent the vehicle to that on which the device 10 is operatively engaged. Such an impact sensor 18 can be one or a combination of a movement sensor, such as an accelerometer to sense device 10 movement and/or a microphone to sense impact sounds or movement sounds of vehicles and/or sounds of a person moving proximate to the vehicle on which the device 10 is engaged.

For example only, impact sounds can be the sound of a slamming door, or a vehicle engine, and movement sounds can be the sound of another vehicle pulling alongside the device 10 and/or the voices of humans adjacent the vehicle on which the device 10 is engaged. The impact sensor 18 will generate a trigger signal to the electronic circuits and electronic memory running software and/or switching within the housing 12 to energize the device 10 to activate it to an “on” state from the de energized “off” state. The device 10 may remain in this on state for a duration of time, once activated, where no new sounds or movement are sensed by the impact sensor 18. The onboard electric power source, such as a battery (not shown but well known) will provide power to a circuit or circuits energizing the impact sensor 18 to monitor for impact, movement, or sound, whereby the trigger signal is generated which will save power from having the entire device energized at all times.

In an alternative mode, the device 10 can be actuated to an on or energized state from an off or de-energized state by an on button 11. When in the on or energized state, the cameras 20 and microphones 21 are electrically energized and will capture digital video and digital audio which are preferably stored in electronic memory held within the housing. Alternatively, the digital signals from the cameras or microphone or other sensors may be transmitted for storage in electronic memory to a smartphone or other computer device with electronic memory.

While not shown but well known, the device 10 will have a power source, such as a battery and microprocessor and electronic memory held within an internal cavity, which will operate with software stored and running thereon to perform the steps and tasks noted herein to activate various actions of the device 10 and to store electronic video from the plurality of video cameras 20 of the device 10. Such electronic memory and electronic components which will capture and store digital audio and/or video signals from onboard cameras 20 or microphones 21 are well known as is software configured to the operation of receiving such audio and video signals and communicating such to electronic memory.

The housing 12 has at least one and preferably a plurality of video cameras 20 thereon. As shown and noted above, the video cameras 20 are preferably positioned to capture video imagery from multiple angles to therefor capture video from different positions adjacent the vehicle 22 on which the device 10 is operatively engaged.

Additionally shown in FIG. 1 is a secondary housing 24 which may be positioned remote from the housing 12. One or more such secondary housings 24 can be positioned on door windows, the rear windshield, or front windshield or other locations. One or a plurality of video cameras 20 positioned on the secondary housings 24 will operate, when the device 10 is activated, to capture additional video streams of areas around the vehicle 22. These video streams along with those from the housing 12 can be stored in electronic memory within the housing 12 and retrieved therefrom. Audio can also be captured by microphones 21 on one or both of the housing 12 and the secondary housing 24. The secondary housing 24 has a transmitter to wirelessly communicate with the electronic receiving and storage components in the housing 12 to capture secondary video streams and, where present, secondary audio streams for storage in memory and playback.

Also shown in FIG. 1 is a GPS component 26 which will receive signals from satellites and or cell towers as to the exact terrestrial location of the device 10. The signals, so received, using software running on the microprocessor operating to the task of location stamping, can also be employed to impart a geographic location-stamp to each recorded video and audio stream in the media files stored in electronic memory in the housing 12 for later playback. This will enable the device 10 to self-authenticate its location and the location of any captured video or audio of media files from the surrounding area stored in electronic memory for later viewing and playback.

In the same fashion, an onboard electronic clock (not shown but well known) may operate to provide ongoing time and dates to the microprocessor. Software running thereon and operating to impart dating to captured media files of captured video and audio, where present, can operate to electronically encode the captured videos with electronic time and date stamping, which can be viewable as indicia within the frame of depicted videos. The electronic clock can also employ time signals from the GPS signal to determine current time.

Additionally shown in FIGS. 1 and 7-8, the device 10 can include warning lights 28 which will blink or otherwise illuminate, once the device 10 is activated, to provide a visual warning of the presence of the device 10. Also shown, illuminated warning indicia 30 can be positioned upon the device 10, such as in the form of text which illuminates or blinks, which will provide visually discernable wording messages to persons adjacent the window of a vehicle 22 on which the device 10 is located that their actions are being recorded.

In FIG. 2 is shown a typical positioning of the device 10 of FIGS. 1, 5, or 7, adjacent a door window of a vehicle 22. Also shown are the optional secondary housing 24 and video cameras thereon positioned in an adjacent door window. Of course, the depictions only show one manner of deployment of the device 10 and those skilled in the art will realize others are available.

As noted, the device 10 herein can be configured with a deployable support member 34 which may fold out to a deployed position from a recess within the rear or side of the housing 12. This allows positioning of the device 10, not only on door windows having window slots therein, but also adjacent the front or rear windshields of a vehicle 22. The support member 34, when deployed, will hold the housing 12 in a correct position on the top surface of a front dashboard or rear position adjacent the rear windshield, to allow for the capture of video steams by the video cameras 20 mounted thereon.

As noted, the video captured by cameras 20, along with audio where microphones 21 are present, may be stored in electronic memory as media files which can be played later on a device having a video display and sound. Such may be communicated to another electronic device, such as a smartphone or computer, having a video display for later playback. A USB port 31 can be provided for wired offloading of media files or a wireless connection by blue tooth or WiFi to a transceiver 19 in the housing 12 can be employed for transporting electronic media files held in electronic memory of the device 10. The same wireless communication between a transceiver in a secondary housing is employed to communicate audio and video to be stored in electronic memory in the housing 12. As noted, such wired and wireless components are well known.

In FIG. 4 is shown a mode of the device 10 herein wherein the projecting mount 14 is connected to the housing 12 in a pivoting engagement 35. In this particularly preferred mode of the device 10, the projecting mount 14 can be rotated to various angles relative to the side surface of the housing 12 to allow for positioning on door windows having angled surfaces adjacent the slot or having windows which angle inward toward the center of the vehicle 22 or outward away from it. This pivoting engagement 35, in all modes of the device 10 herein, is preferred, as experimentation has found it to allow for such tilting of the housing 12 to move it to accommodate such inward or outward slanting of the windows in the doors, while still positioning the housing 12 on a location the capture audio and video and to communicate visual warnings which can be seen by persons adjacent the window.

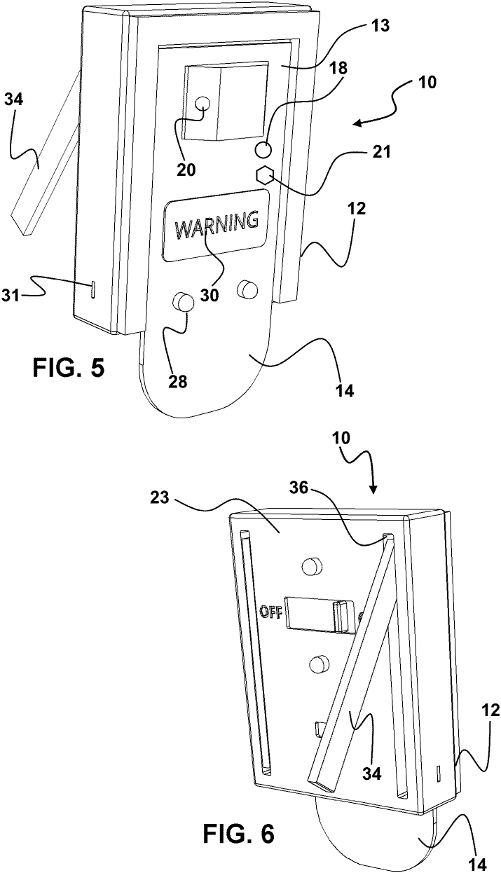

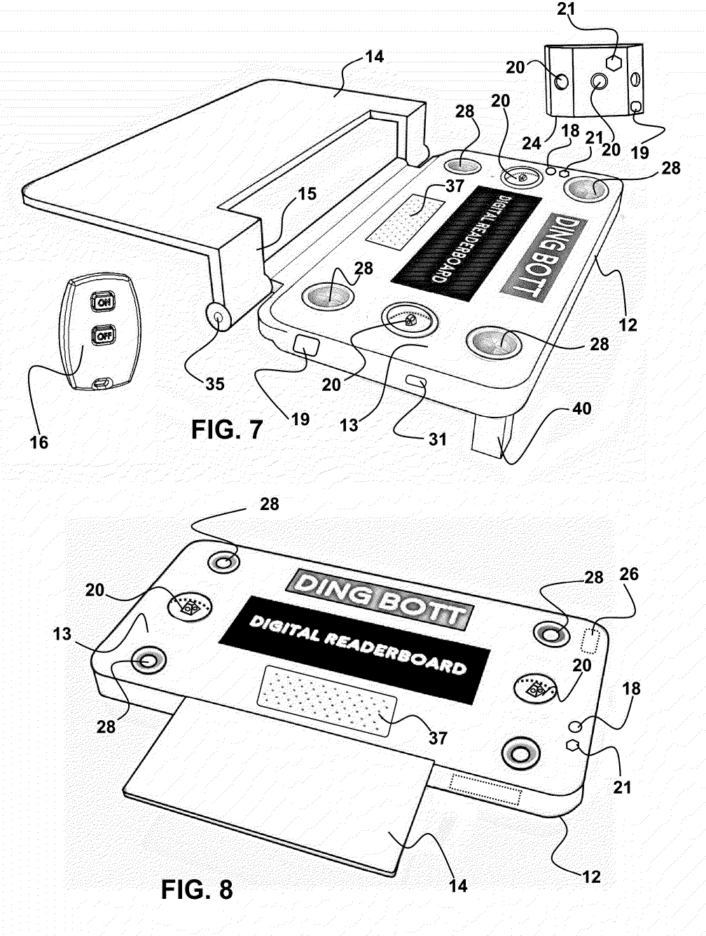

Shown in FIGS. 5-6 are the support members 34 which may be provided to allow for front and rear windshield positioning. As shown, the support member 34 is rotationally engaged to the housing 12 and may pivot from and into a positioning within a recess 36 in the surface of the housing 12. This support member 34, while not shown in FIGS. 7-11, can be provided in combination with the projecting mount 14, in all modes of the device 10 herein, to maximize mounting possibilities for use. In this fashion, the housing 12 is mountable both using a window slot in a door and on a front or rear dashboard.

FIG. 7 depicts a mode of the device 10 having a pivoting engagement 35 of a projecting mount 14, as shown above. Also included and preferred is an offset portion 15 of the projecting mount extending between the pivoting engagement 35 and the projecting mount 14. As noted, this is preferred to allow for an offset locating of the housing 12, such as in FIG. 11, when the projecting mount 14 is slid into the door slot of a vehicle, thereby positioning the housing 12 spaced from the window by a distance, such as the length of the offset portion 15. As can be seen in FIG. 11 the housing 12 can tilt toward the window 33 of a car door from this offset position where the window 33 aligns with the projecting mount 14. Using the offset provided by the offset portion 15, the housing 12 and camera 20 thereon can also tilt toward and away from the window more easily due to the offset portion 15. This will allow, if desired, for positioning the housing 12 to give a downward angle to the camera 20 to capture sides of the adjacent vehicle and/or person. A loudspeaker 37 can be included in this and other modes of the device 10 to emit an audible warning to persons who are proximate to the vehicle 22 to augment the warning lights 28 which are preferably a mixture of red and blue in color.

The device 10, as in FIGS. 7-11, is configured with the same components as that of FIGS. 1-6 and operates as described above. The housing 12, as shown, will have the same warning lights 28, GPS 26, cameras 20, and microphone 21, where included, to capture audio and to combine with the accelerometer for the impact sensor 18.

Preferably, the video camera 20 or cameras are positioned to project above the surface of the housing 12 on which they are operatively engaged, such as is shown in FIGS. 7-11. This positioning allows for better video capture from multiple angles versus a flush mount where the cameras 20 would not be able to capture video from sides. Preferably, there are a plurality of video cameras 20 which point different directions and angles from the position, to thereby capture multiple video streams from multiple angles adjacent the vehicle 22. For example, cameras 20, such as shown in FIG. 4 which have axes which run substantially 90 degrees and substantially 40-60 degrees relative to the front or first surface 13 of the housing 12 on which they are shown engaged. By first surface 13 is meant the surface facing the window 33 of the car 22 or the windshield with the housing 12 operatively positioned thereon. This first surface 13 is opposite the rear or second surface 23 of the housing 12.

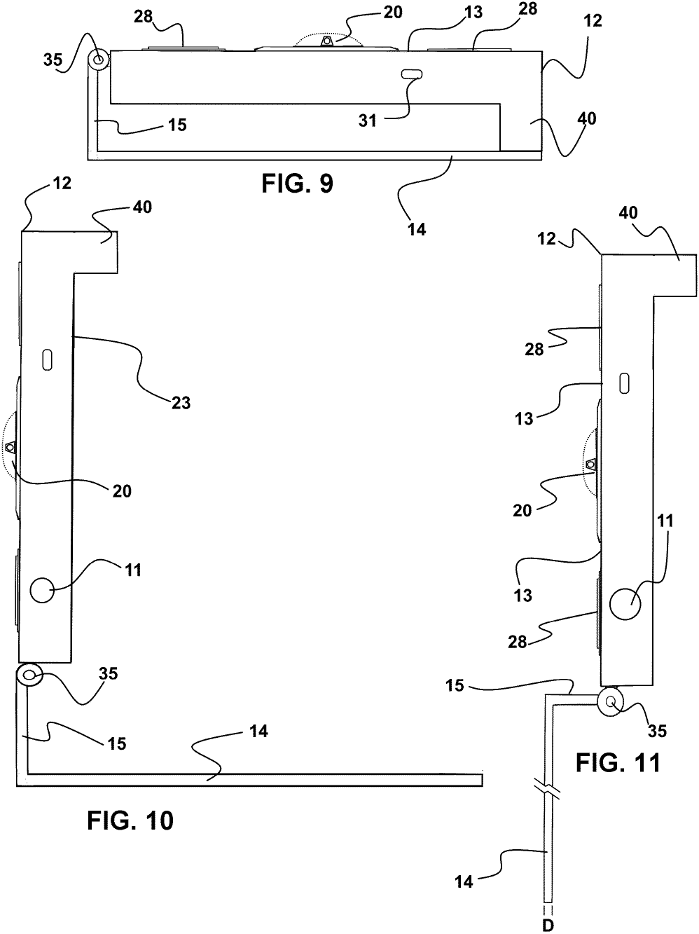

In FIG. 9 is shown a side view of the housing 12 of the device 10 of FIGS. 7-8 showing the projecting mount 14 rotated on the pivoting engagement 35 to a stowed position wherein the projecting mount 14 contacts a surface of the housing 12. As depicted, the housing 12 has a pair of projections 40 extending from the second surface 23 or rear surface thereof. The projections 40 are sized to contact against a distal end area of the projecting mount 14 when it is spaced from the pivoting engagement 35 by the offset portion 15, to hold the projecting mount 14 substantially parallel to the second surface 23 of the housing 12 where it is planar.

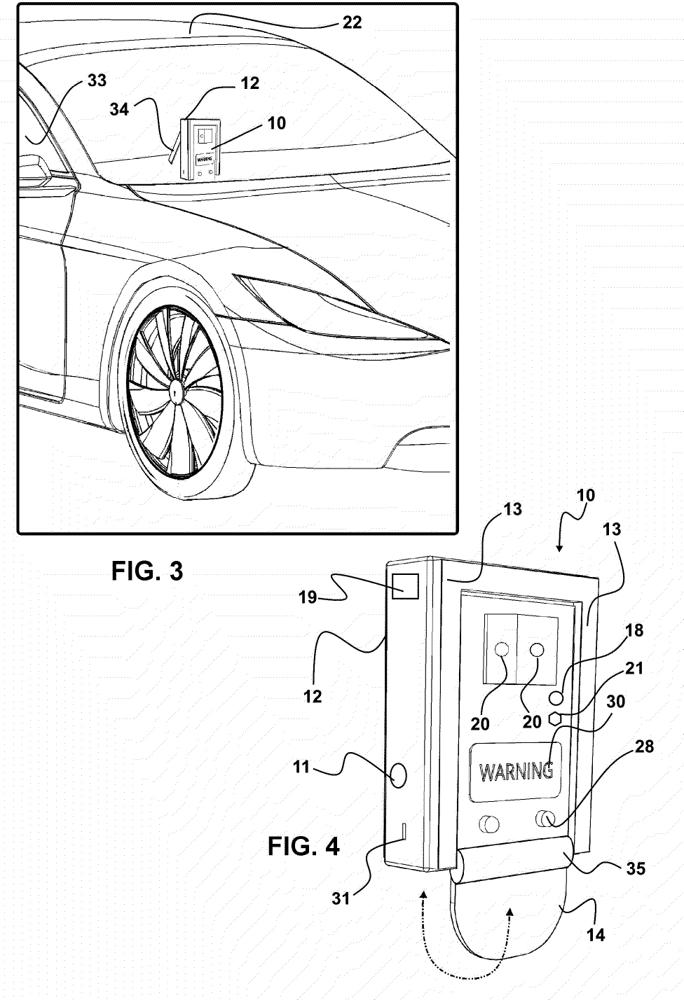

FIG. 10 shows a side view of the device 10 wherein the projecting portion 14 extending from the offset portion 15 is rotated on the pivoting engagement 35 to a position to support the housing 12 on a front or rear dashboard area as in FIG. 3. The offset 15 portion and the pivoting connection 35 are particularly preferred as such enables the projecting portion 14 to rotate and be positioned on a dashboard or the like to provide such a support which would not be present without it.

FIG. 11 depicts the device 10 in the mode of FIGS. 7-8 wherein the projecting portion 14 is rotated to engage a door window slot as in FIG. 2. The preferred offset portion 15 as can be discerned, locates the housing 12 and the first or front surface 13 thereof, a space from the interior surface of the door mounted window when the projecting portion 14 is engaged into and aligned with the slot for the window. The offset portion 15 thus allows for an angled positioning of the housing 12 and the cameras 20 and other components operatively positioned thereon. As noted this is very important when the device 10 is employed with vehicles 22 where the windows in the doors slant inward or outward from the center axis of the vehicle 22.

While all of the fundamental characteristics and features of the removably engageable vehicle monitoring system herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth.

It should also be understood that various substitutions, modifications, and variations may be made by those skilled in the art, without departing from the spirit or scope of the invention. Consequently, all such modifications and variations and substitutions are included within the scope of the invention as defined by the following claims.

What is claimed is:

1. A vehicle monitor apparatus, comprising:
a housing having a first surface opposite a second surface;
a projecting mount extending from a first end thereof in an engagement with said housing, to a distal end of said projecting mount;
a camera positioned on said housing for capturing digital images for storing in electronic memory within said housing;
said distal end of said projecting mount positionable into a window slot for a door window of a vehicle door, to hold said housing in a first mounted position on said door; and
said camera operating to capture digital video of an area outside said vehicle in an area adjacent said vehicle door;
an electric power source operatively engaged with said housing for providing electric energy to said camera and electronic circuits and electronic memory in said housing; and
said digital video being communicated to electronic memory wherein it is subsequently employable for display on a video display to discern activity occurring in said area adjacent said vehicle door.

2. The vehicle monitor apparatus of claim 1 additionally comprising:
an impact sensor for communicating a trigger signal upon sensing thereby of movement or sound adjacent said housing wherein said trigger signal activates said monitor from an off state, to an on state; and
‘said camera being energized to capture said digital video only with said monitor in said on state, whereby energy from said electric power source is conserved when said monitor is in said off state.

3. The vehicle monitor apparatus of claim 2 additionally comprising:
warning lights positioned on said housing; and
said warning lights emitting light therefrom when said monitor is activated by said trigger signal to said on state.

4. The vehicle monitor apparatus of claim 1 additionally comprising:
said engagement with said housing of said first end of said projecting mount is a pivoting engagement;
said housing is pivotable to varying angles on said pivoting engagement with said housing while held in said first mounted position by said distal end of said projecting mount located in said window slot of a vehicle door; and
said varying angles of said housing allowing a positioning thereof for varying viewing angles of said camera.

5. The vehicle monitor apparatus of claim 2 additionally comprising:
said engagement with said housing of said first end of said projecting mount is a pivoting engagement;
said housing is pivotable to varying angles on said pivoting engagement with said housing while held in said first mounted position by said distal end of said projecting mount located in said window slot of a vehicle door; and
said varying angles of said housing allowing a positioning thereof for varying viewing angles of said camera.

6. The vehicle monitor apparatus of claim 3 additionally comprising:
said engagement with said housing of said first end of said projecting mount is a pivoting engagement;
said housing is pivotable to varying angles on said pivoting engagement with said housing while held in said first mounted position by said distal end of said projecting mount located in said window slot of a vehicle door; and
said varying angles of said housing allowing a positioning thereof for varying viewing angles of said camera.

7. The vehicle monitor apparatus of claim 4 additionally comprising:
an offset portion, said offset portion extending from a first end thereof in said pivoting engagement with said housing, to a second end of said offset portion connected to said first end of said projecting mount;
a distance of said offset portion defining a space formed between a first surface of said housing facing said door window with said housing in said first mounted position, and said door window; and
said housing tiltable on said pivoting mount into said space wherein said camera engaged to said housing is positioned at a downward angle.

8. The vehicle monitor apparatus of claim 5 additionally comprising:
an offset portion, said offset portion extending from a first end thereof in said pivoting engagement with said housing, to a second end of said offset portion connected to said first end of said projecting mount;
a distance of said offset portion defining a space formed between a first surface of said housing facing said door window with said housing in said first mounted position, and said door window; and
said housing tiltable on said pivoting mount into said space wherein said camera engaged to said housing is positioned at a downward angle.

9. The vehicle monitor apparatus of claim 6 additionally comprising:
an offset portion, said offset portion extending from a first end thereof in said pivoting engagement with said housing, to a second end of said offset portion connected to said first end of said projecting mount;
a distance of said offset portion defining a space formed between a first surface of said housing facing said door window with said housing in said first mounted position, and said door window; and
said housing tiltable on said pivoting mount into said space wherein said camera engaged to said housing is positioned at a downward angle.

10. The vehicle monitor apparatus of claim 10 additionally comprising:
said projecting mount having a substantially planar side surface; and
said offset portion extending from said pivoting engagement being rotatable to position said planar side surface of said projecting mount atop a dashboard of said vehicle thereby forming a secondary mount for said housing sitting atop said dashboard.

11. The vehicle monitor apparatus of claim 8 additionally comprising:
said projecting mount having a substantially planar side surface; and
said offset portion extending from said pivoting engagement being rotatable to position said planar side surface of said projecting mount atop a dashboard of said vehicle thereby forming a secondary mount for said housing sitting atop said dashboard.

12. The vehicle monitor apparatus of claim 9 additionally comprising:
said projecting mount having a substantially planar side surface; and
said offset portion extending from said pivoting engagement being rotatable to position said planar side surface of said projecting mount atop a dashboard of said vehicle thereby forming a secondary mount for said housing sitting atop said dashboard.

13. The vehicle monitor apparatus of claim 7 additionally comprising:
a secondary housing locatable on said vehicle in a position remote to said housing;
a secondary camera engaged to said secondary housing; and
a wireless transmitter on said secondary housing communicating secondary digital images generated by said secondary camera to a receiver on said housing for storage in said electronic memory within said housing.

14. The vehicle monitor apparatus of claim 8 additionally comprising:
a secondary housing locatable on said vehicle in a position remote to said housing;
a secondary camera engaged to said secondary housing; and
a wireless transmitter on said secondary housing communicating secondary digital images generated by said secondary camera to a receiver on said housing for storage in said electronic memory within said housing.

15. The vehicle monitor apparatus of claim 9 additionally comprising:
a secondary housing locatable on said vehicle in a position remote to said housing;
a secondary camera engaged to said secondary housing; and
a wireless transmitter on said secondary housing communicating secondary digital images generated by said secondary camera to a receiver on said housing for storage in said electronic memory within said housing.

16. The vehicle monitor apparatus of claim 10 additionally comprising:
a secondary housing locatable on said vehicle in a position remote to said housing;
a secondary camera engaged to said secondary housing; and
a wireless transmitter on said secondary housing communicating secondary digital images generated by said secondary camera to a receiver on said housing for storage in said electronic memory within said housing.

17. The vehicle monitor apparatus of claim 11 additionally comprising:
a secondary housing locatable on said vehicle in a position remote to said housing;
a secondary camera engaged to said secondary housing; and
a wireless transmitter on said secondary housing communicating secondary digital images generated by said secondary camera to a receiver on said housing for storage in said electronic memory within said housing.

18. The vehicle monitor apparatus of claim 12 additionally comprising:
a secondary housing locatable on said vehicle in a position remote to said housing;
a secondary camera engaged to said secondary housing; and
a wireless transmitter on said secondary housing communicating secondary digital images generated by said secondary camera to a receiver on said housing for storage in said electronic memory within said housing.
